(19) United States
(12) Patent Application Publication
(10) Pub. No.: US 2003/0130452 A1
(43) Pub. Date: Jul. 10, 2003

(54) Copolymers of ethylene with various norbornene derivatives

(76) Inventors: Lynda Kaye Johnson, Wilmington, DE (US); Lin Wang, Hockessin, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/269,151

(22) Filed: Oct. 11, 2002

Related U.S. Application Data
(60) Provisional application No. 60/328,736, filed on Oct. 12, 2001.

(51) Int. Cl. C08F 4/06

(52) U.S. Cl. 526/172; 526/282

(57) ABSTRACT

Ethylene and norbornene-type monomers are efficiently copolymerized by certain metal complexes, particularly nickel complexes, containing selected anionic and neutral bidentate ligands. The polymerization process is tolerant of polar functionality on the norbornene-type monomer and can be carried out at elevated temperatures.

### FIELD OF THE INVENTION

This invention is directed to a method of copolymerizing ethylene with cycloolefin monomers, often referred to as norbornene-type or NB-type monomers. More specifically, the method employs transition metal and lanthanide catalysts, with nickel catalysts being preferred. The polymers obtained by the method of this invention are addition copolymers that may be random or alternating, crystalline or amorphous, and polar or nonpolar in character.

### TECHNICAL BACKGROUND OF THE INVENTION

Addition copolymers of ethylene and norbornene-type monomers are well known and can be prepared using a variety of catalysts disclosed in the prior art. This general type of copolymers can be prepared using free radical catalysts disclosed in U.S. Pat. No. 3,494,897; titanium tetrachloride and diethylaluminum chloride as disclosed in DD109224 and DD222317 (VEB Leuna); or a variety of vanadium compounds, usually in combination with organoaluminum compounds, as disclosed in U.S. Pat. No. 4,614,778. The copolymers obtained with these catalysts are random copolymers.

U.S. Pat. No. 4,948,856 discloses preparing generally alternating copolymers by the use of vanadium catalysts which are soluble in the norbornene-type monomer and a co-catalyst which may be any alkyl aluminum halide or alkylalkoxy aluminum halide.

U.S. Pat. No. 5,629,398 discloses copolymerization of said monomers in the presence of catalysts such as transition metal compounds, including nickel compounds, and a compound which forms an ionic complex with the transition metal compound or a catalyst comprising said two compounds and an organoaluminum compound.

Metallocene catalysts were used to prepare copolymers of cycloolefins and alpha-olefins as disclosed in U.S. Pat. No. 5,003,019, U.S. Pat. No. 5,087,677, U.S. Pat. No. 5,371,158 and U.S. Pat. No. 5,324,801.

U.S. Pat. No. 5,866,663 discloses processes of polymerizing ethylene, alpha-olefins and/or selected cyclic olefins which are catalyzed by selected transition metal compounds, including nickel complexes of diimine ligands, and sometimes also a cocatalyst. This disclosure provides, however, that when norbornene or a substituted norbornene is used, no other olefin can be present.

U.S. Pat. No. 6,265,506 discloses a method of producing generally amorphous copolymers of ethylene and at least one norbornene-type comonomer using a cationic palladium catalyst. Copolymerizations exemplified were carried out at ambient temperature and ethylene pressures ranging from 80 to 300 psig.

U.S. Pat. No. 5,929,181 discloses a method for preparing generally amorphous copolymers of ethylene and norbornene-type monomers with neutral nickel catalysts. The exemplified copolymerizations were carried out at reactor temperatures ranging from 5 to 60° C., primarily at ambient temperature. In comparative copolymerizations, copolymer yields typically decreased with increasing temperature, often peaking below ambient temperature. Direct copolymerization of norbornene-type monomers containing acidic functionality was claimed, but not exemplified, with the acidic functionality always being protected prior to copolymerization.

All of the above-identified references are incorporated by reference herein for all purposes as if fully set forth.

### SUMMARY OF THE INVENTION

This invention discloses a process for the copolymerization of ethylene, one or more norbornene (NB)-type monomers, and, optionally, one or more additional polymerizable olefins utilizing selected Group 3 through 11 (IUPAC) transition metal or lanthanide metal complexes. The transition metal or lanthanide complex may in and of itself be an active catalyst, or may be “activated” by contact with a cocatalyst/activator. Copolymers so produced may be random or alternating, and crystalline or amorphous, depending on the choice of catalyst and/or the relative ratio of the monomers used.

In one aspect of the present process, the catalyst comprises a Group 3 through 11 (IUPAC) transition metal or lanthanide metal complex of a ligand of the formula (I)

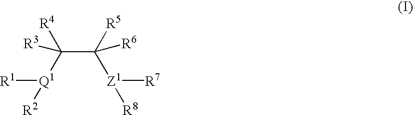

wherein:

Z¹ is nitrogen or oxygen; and

Q¹ is nitrogen or phosphorous;

provided that:

when Q¹ is phosphorous and Z¹ is nitrogen: R¹ and R² are each independently hydrocarbyl or substituted hydrocarbyl having an Eₛ of about −0.90 or less; R³, R⁴, R⁵, R⁶ and R⁷ are each independently hydrogen, hydrocarbyl or substituted hydrocarbyl; and R⁸ is aryl or substituted aryl, provided that any two of R³, R⁴, R⁵, R⁶, R⁷ and R⁸ vicinal or geminal to one another together may form a ring;

when Q¹ is phosphorous and Z¹ is oxygen: R¹ and R² are each independently hydrocarbyl or substituted hydrocarbyl having an Eₛ of about −0.90 or less; R³ and R⁴ are each independently hydrogen, hydrocarbyl or substituted hydrocarbyl; R⁵ and R⁷ taken together form a double bond; R⁸ is not present; and R⁶ is —OR⁹, —NR¹⁰R¹¹ hydrocarbyl or substituted hydrocarbyl, wherein R⁹ is hydrocarbyl or substituted hydrocarbyl, and R¹⁰ and R¹¹ are each independently hydrogen, hydrocarbyl or substituted hydrocarbyl;

when Q¹ is nitrogen: R¹ is hydrocarbyl or substituted hydrocarbyl having an Eₛ of about −0.90 or less; R² and R³ are each independently hydrogen, hydrocarbyl or substituted hydrocarbyl, or taken together form a ring or a double bond; R⁴ is hydrogen, hydrocarbyl or substituted hydrocarbyl; Z¹ is oxygen; R⁶ and R⁷ taken together form a double bond; R⁸ is not present; R⁵ is —OR¹², —R¹³ or —NR¹⁴R¹⁵, wherein R¹² and R¹³ are each independently hydrocarbyl or substituted hydrocarbyl, and R¹⁴ and R¹⁵ are each hydrogen, hydrocarbyl or substituted hydrocarbyl; provided that when R² and R³ taken together form an aromatic ring, R¹ and R⁴ are not present.

In a second aspect of the present process, the catalyst comprises a Group 3 through 11 (IUPAC) transition metal or lanthanide metal complex of a ligand of the formula (II)

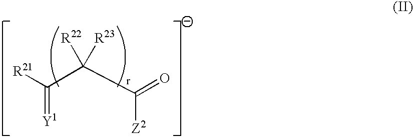

wherein:

Y¹ is oxo, NRₐ¹² or PRₐ¹²

Z² is O, NRₐ¹³, S or PRₐ¹³;

each of R²¹, R²² and R²³ is independently hydrogen, hydrocarbyl, substituted hydrocarbyl or a functional group;

r is 0 or 1;

each Rₐ¹² is independently hydrogen, hydrocarbyl, substituted hydrocarbyl or a functional group;

each Rₐ¹³ is independently hydrogen, hydrocarbyl, substituted hydrocarbyl or a functional group;

and provided that any two of R²¹, R²² and R²³ geminal or vicinal to one another taken together may form a ring.

In a third aspect of the present process, the catalyst comprises a Group 3 through 11 (IUPAC) transition metal or lanthanide metal complex of a ligand of the formula (III), (IV) or (V)

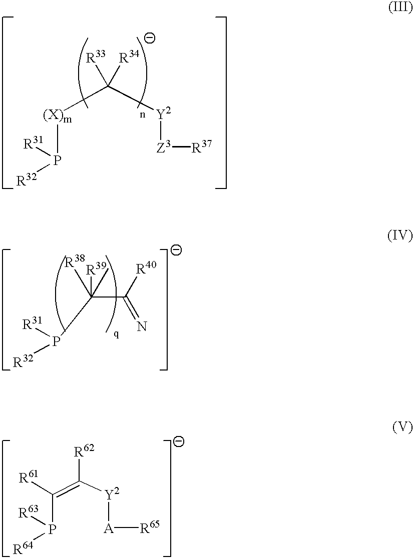

wherein:

R³¹ and R³² are each independently hydrocarbyl, substituted hydrocarbyl or a functional group;

Y² is CR⁴¹R⁴², S(T), S(T)₂, P(T)Q³, NR⁶⁶ or NR⁶⁶NR⁶⁶;

X is O, CR³⁵R³⁶ or NR³⁵;

A is O, S, Se, N, P or As;

Z³ is O, S, Se, N, P or As;

each Q³ is independently hydrocarbyl or substituted hydrocarbyl;

R³³, R³⁴, R³⁵, R³⁶, R⁴¹ and R⁴² are each independently hydrogen, hydrocarbyl, substituted hydrocarbyl or a functional group;

R³⁷ is hydrogen, hydrocarbyl, substituted hydrocarbyl or a functional group, provided that when Z³ is O, S or Se, R³⁷ is not present;

R³⁸ and R³⁹ are each independently hydrogen, hydrocarbyl, substituted hydrocarbyl or a functional group;

R⁴⁰ is hydrogen, hydrocarbyl, substituted hydrocarbyl or a functional group;

each T is independently ═O or ═NR⁶⁰;

R⁶⁰ is hydrogen, hydrocarbyl, substituted hydrocarbyl or a functional group;

R⁶¹ and R⁶² are each independently hydrogen, hydrocarbyl, substituted hydrocarbyl or a functional group;

R⁶³ and R⁶⁴ are each independently hydrocarbyl or substituted hydrocarbyl, provided that each is independently an aryl substituted in at least one position vicinal to the free bond of the aryl group, or each independently has an Eₛ of −1.0 or less;

R⁶⁵ is hydrogen, hydrocarbyl, substituted hydrocarbyl or a functional group, provided that when A is O, S or Se, R⁶⁵ is not present;

each R⁶⁶ is independently hydrogen, hydrocarbyl, substituted hydrocarbyl or a functional group;

m is 0 or 1;

s is 0 or 1;

n is 0 or 1; and

q is 0 or 1;

and provided that:

any two of R³³ , R³⁴, R³⁵, R³⁶, R³⁸, R³⁹, R⁴¹ and R⁴² bonded to the same carbon atom taken together may form a functional group;

any two of R³¹, R³², R³³, R³⁴, R³⁵, R³⁶, R³⁷, R³⁸, R³⁹, R⁴¹, R⁴², R⁶¹, R⁶², R⁶³, R⁶⁴, R⁶⁵ and R⁶⁶ bonded to the same atom or vicinal to one another taken together may form a ring; and

when said ligand is (III), Y² is C(O), Z³ is O, and R³¹ and R³² are each independently hydrocarbyl, then R³¹ and R³² are each independently an aryl substituted in one position vicinal to the free bond of the aryl group, or R³¹ and R³² each independently have an Eₛ of −1.0 or less.

In a preferred embodiment of the present invention, the metal complex is based upon Ni, Pd, Ti or Zr, with Ni being especially preferred. Copolymerizations of norbornene-type monomers catalyzed by the nickel catalysts disclosed herein often exhibit high productivities. In particular, high productivities are often observed at elevated temperatures and/or in the presence of polar norbornene-type monomers relative to previously reported nickel-catalyzed norbornene-type monomer copolymerizations.

These and other features and advantages of the present invention will be more readily understood by those of ordinary skill in the art from a reading of the following detailed description. It is to be appreciated that certain features of the invention which are, for clarity, described below in the context of separate embodiments, may also be provided in combination in a single embodiment. Conversely, various features of the invention which are, for brevity, described in the context of a single embodiment, may also be provided separately or in any subcombination.

### DETAILED DESCRIPTION OF THE PREFERRED EMBODIMENTS

The following definitions are used herein and should be referred to for further exemplification.

A “hydrocarbyl group” is a univalent group containing only carbon and hydrogen. As examples of hydrocarbyls may be mentioned unsubstituted alkyls, cycloalkyls and aryls. If not otherwise stated, it is preferred that hydrocarbyl groups (and alkyl groups) herein contain 1 to about 30 carbon atoms.

By “substituted hydrocarbyl” herein is meant a hydrocarbyl group that contains one or more substituent groups which are inert under the process conditions to which the compound containing these groups is subjected (e.g., an inert functional group, see below). By “inert” is meant that the substituent groups do not substantially deleteriously interfere with the polymerization process or operation of the polymerization catalyst system. If not otherwise stated, it is preferred that substituted hydrocarbyl groups herein contain 1 to about 30 carbon atoms. Included in the meaning of “substituted” are heteroaromatic rings. In a substituted hydrocarbyl, all of the hydrogens may be substituted, as in trifluoromethyl.

By “(inert) functional group” herein is meant a group other than hydrocarbyl or substituted hydrocarbyl which is inert under the process conditions to which the compound containing the group is subjected. By “inert” is meant that the functional groups do not substantially deleteriously interfere with any process described herein that the compound in which they are present may take part in. Examples of functional groups include halo (fluoro, chloro, bromo and iodo), thioether, tertiary amino and ether such as —OR⁹⁹ wherein R⁹⁹ is hydrocarbyl or substituted hydrocarbyl, silyl, or substituted silyl. In cases in which the functional group may be near a transition metal atom, the functional group alone should not coordinate to the metal atom more strongly than the groups in those compounds that are shown as coordinating to the metal atom, that is, they should not displace the desired coordinating group.

By a “cocatalyst” or a “catalyst activator” is meant one or more compounds that react with a transition metal compound to form an activated catalyst species. The cocatalysts that may be used for metal-catalyzed polymerizations are well known in the art and include borane, organolithium, organomagnesium, organozinc and organoaluminum compounds.

By an “alkyl aluminum compound”, herein, is meant a compound in which at least one alkyl group is bound to an aluminum atom. Other groups such as, for example, alkoxide, hydride and halogen may also be bound to aluminum atoms in the compound.

Useful organoboranes include tris(pentafluorophenyl)boron, tris ((3,5-trifluoromethyl)phenyl)boron and triphenylboron.

By “neutral Lewis base” is meant a compound, which is not an ion and that can act as a Lewis base. Examples of such compounds include ethers, amines, sulfides and organic nitriles.

By “neutral Lewis acid” is meant a compound, which is not an ion and that can act as a Lewis acid. Examples of such compounds include boranes, alkylaluminum compounds, aluminum halides and antimony [V] halides.

By “cationic Lewis acid” is meant a cation that can act as a Lewis acid. Examples of such cations are lithium, sodium and silver cations.

By a “monoanionic ligand” is meant a ligand with one negative charge.

By a “neutral ligand” is meant a ligand that is not charged.

“Alkyl group” and “substituted alkyl group” have their usual meaning (see above for substituted under substituted hydrocarbyl). Unless otherwise stated, alkyl groups and substituted alkyl groups preferably have 1 to about 30 carbon atoms.

By a “π-allyl group” is meant a monoanionic ligand comprised of 1 sp³ and two sp² carbon atoms bound to a metal center in a delocalized η³ fashion indicated by

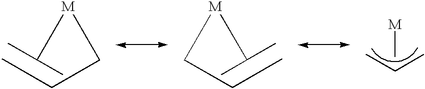

The three carbon atoms may be substituted with other hydrocarbyl groups or functional groups. Typical π-allyl groups include

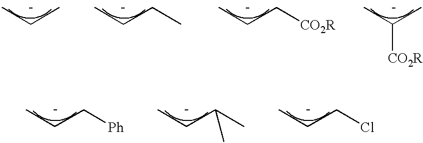

wherein

R is hydrocarbyl.

“Vinyl group” has its usual meaning.

By a “hydrocarbon olefin” is meant an olefin containing only carbon and hydrogen.

By a “polar (co)monomer” or “polar olefin” is meant an olefin which contains elements other than carbon and hydrogen. In a “vinyl polar comonomer,” the polar group is attached directly to a vinylic carbon atom, as in acrylic monomers. When copolymerized into a polymer the polymer is termed a “polar copolymer”. Useful polar comonomers are found in previously incorporated U.S. Pat. No. 5,866,663, as well as in WO9905189, U.S. Pat. No. 6,265,507, U.S. Pat. No. 6,090,900, and S. D. Ittel, et al., Chem. Rev., vol. 100, p. 1169-1203(2000), all of which are also incorporated by reference herein for all purposes as if fully set forth. Also included as a polar comonomer is CO (carbon monoxide).

By a “norbornene-type monomer” is meant ethylidene norbornene, dicyclopentadiene, or a compound of the formula (VI)

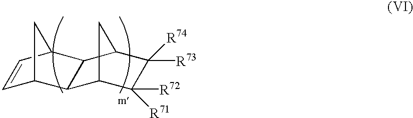

wherein

m′ is an integer from 0 to 5, and each of R⁷¹ to R⁷⁴ independently represents a hydrogen, hydrocarbyl, substituted hydrocaryl or a functional group. The norbornene may be also substituted by one or more hydrocarbyl, substituted hydrocarbyl or functional groups in other positions, with the exception of the vinylic hydrogens, which remain. Two or more of R⁷¹ to R⁷⁴ may also be taken together to form a cyclic group.

By a “polar norbornene-type (co)monomer” or “polar norbornene” is meant a norbornene-type monomer which contains elements other than carbon and hydrogen. That is, the polar norbornene-type monomer is substituted with one or more polar groups, with the exception of the vinylic hydrogens which remain intact. Useful polar norbornene-type monomers are found in U.S. Pat. No. 6,265,506, U.S. Pat. No. 5,929,181, PCT/US01/42743 (“Compositions for Microlithography”, filed concurrently herewith) and Buchmeiser, M. R. Chem. Rev. vol. 100, p. 1565-1604 (2000), all of which are incorporated by reference herein for all purposes as if fully set forth.

Preferred NB-type monomers in the present invention may be selected from those represented by the formula (VI), wherein m′ is an integer from 0 to 5, and each of R⁷¹ to R⁷⁴ independently represents

hydrogen;

a halogen atom;

a linear or branched (preferably C₁ to C₁₀) alkyl;

an aromatic or saturated or unsaturated cyclic group;

a functional substituent selected from the group

—(CH₂)_{n′}—C(O)OR, —(CH₂)_{n′}OR, —(CH₂)_{n′}—OC(O)R,

—(CH₂)_{n′}C(O)R, —(CH₂)_{n′}—OC(O)OR,

—(CH₂)_{n′}C(R)₂CH(R)(C(O)OR), or —(CH₂)_{n′}C(R)₂CH(C(O)OR)₂,

wherein

R represents hydrogen or linear and branched (preferably C₁ to C₁₀) alkyl;

a functional group containing the structure

—C(R_{f})(R_{f}′)OR_{b}

wherein

R_{f} and R_{f}′ are the same or different fluoroalkyl groups of from 1 to 10 carbon atoms or taken together are (CF₂)_{n*} wherein n* is 2 to 10; R_{b} is hydrogen or an acid- or base-labile protecting group;

or a silyl substituent represented by

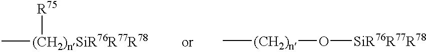

wherein

R⁷⁵ is hydrogen, methyl or ethyl,

each of R⁷⁶, R⁷⁷, and R⁷⁸ independently represents

a halogen selected from bromine, chlorine, fluorine or iodine,

linear or branched (preferably C₁ to C₂₀) alkyl,

linear or branched (preferably C₁ to C₂₀) alkoxy,

linear or branched (preferably C₁ to C₂₀) alkyl carbonyloxy (e.g., acetoxy),

linear or branched (preferably C₁ to C₂₀) alkyl peroxy (e.g., t-butyl peroxy),

substituted or unsubstituted (preferably C₆ to C₂₀) aryloxy,

n′ is an integer from 0 to 10, where preferably n′ is 0,

provided that

R⁷¹ and R⁷² can be taken together to form a (preferably C₁ to C₁₀) alkylidenyl group;

R⁷³ and R⁷⁴ can be taken together to form a (preferably C₁ to C₁₀) alkylidenyl group; or

R⁷¹ and R⁷⁴ can be taken together with the two ring carbon atoms to which they are attached to form a saturated cyclic group of 4 to 8 carbon atoms,

wherein said cyclic group can be substituted by at least one of R⁷² and R⁷³.

Illustrative examples of suitable monomers include 2-norbornene, 5-butyl-2-norbornene, 5-methyl-2-norbornene, 5-hexyl-2-norbornene, 5-decyl-2-norbornene, 5-phenyl-2-norbornene, 5-naphthyl-2-norbornene, 5-ethylidene-2-norbornene, vinylnorbornene, dicyclopentadiene, dihydrodicyclopentadiene, tetracyclododecene, methyltetracyclododecene, tetracyclododecadiene, dimethyltetracyclododecene, ethyltetracyclododecene, ethylidenyl tetracyclododecene, phenyltetracyclododecene, trimers of cyclopentadiene (e.g., symmetrical and asymmetrical trimers), 5-hydroxy-2-norbornene, 5-hydroxymethyl-2-norbornene, 5-methoxy-2-norbornene, 5-t-butoxycarbonyl-2-norbornene, 5-methoxy-carbonyl-2-norbornene, 5-carboxy-2-norbornene, 5-carboxymethyl-2-norbornene, decanoic acid ester of 5-norbornene-2-methanol, octanoic acid ester of 5-norbornene-2-methanol, n-butyric acid ester of 5-norbornene-2-methanol, 5-triethoxysilyl-norbornene, 5-trichlorosilyl-norbornene, 5-trimethylsilyl norbornene, 5-chlorodimethylsilyl norbornene, 5-trimethoxysilyl norbornene, 5-methyldimethoxysilyl norbornene, and 5-dimethylmethoxy norbornene.

Some illustrative examples of representative norbornene-type comonomers containing a fluoroalcohol functional group are presented below:

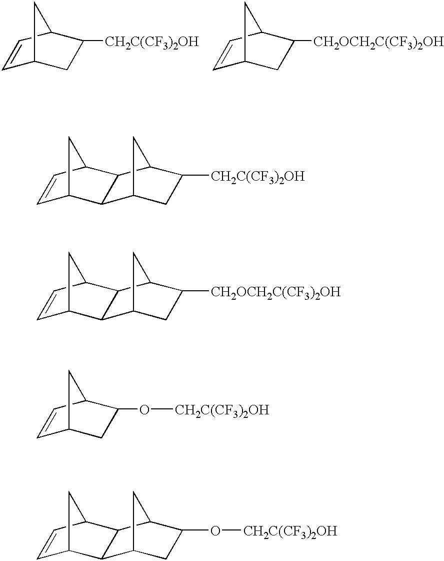

The structures of especially preferred norbornene-type monomers are shown below (together with abrreviations used herein):

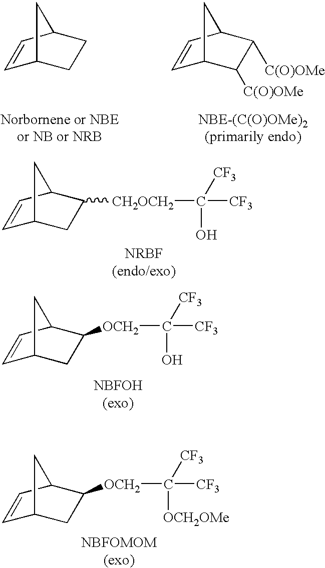

By a “bidentate” ligand is meant a ligand which occupies two coordination sites of the same transition metal atom in a complex.

By a “tridentate” ligand is meant a ligand which occupies three coordination sites of the same transition metal atom in a complex.

By “E_{S}” is meant a parameter to quantify steric effects of various groupings, see R. W. Taft, Jr., J. Am. Chem. Soc., vol. 74, p. 3120-3128 (1952), and M. S. Newman, Steric Effects in Organic Chemistry, John Wiley & Sons, New York, 1956, p. 598-603, which are both hereby included by reference. For the purposes herein, the E_{S} values are those described for o-substituted benzoates in these publications. If the value of E_{S} for a particular group is not known, it can be determined by methods described in these references.

The transition metals preferred herein are in Groups 3 through 11 of the periodic table (IUPAC) and the lanthanides, especially those in the 4^{th} and 5^{th} periods. Preferred transition metals include Ni, Pd, Fe, Co, Cu, Zr, Ti, Cr and V, with Ni, Pd, Zr and Ti being more preferred and Ni being especially preferred. Preferred oxidation states for some of the transition metals are Ti(IV), Ti(III), Zr(IV), Cr(III), Fe(II), Fe(III), Ni(II), Co(II), Co(III), Pd(II), and Cu(I) or Cu(II).

By “under polymerization conditions” is meant the conditions for a polymerization that are usually used for the particular polymerization catalyst system being used. These conditions include things such as pressure, temperature, catalyst and cocatalyst (if present) concentrations, the type of process such as batch, semibatch, continuous, gas phase, solution or liquid slurry etc., except as modified by conditions specified or suggested herein. Conditions normally done or used with the particular polymerization catalyst system, such as the use of hydrogen for polymer molecular weight control, are also considered “under polymerization conditions”. Other polymerization conditions such as presence of hydrogen for molecular weight control, other polymerization catalysts, etc., are applicable with this polymerization process and may be found in the references cited herein.

Ligands of the formula (I) can be found in U.S. Prov. Application No. 60/294,794, filed May 31, 2001 (incorporated by reference herein for all purposes as if fully set forth), along with methods of making these ligands and their transition metal complexes and methods for using these complexes in olefin polymerizations. Preferred ligands (I) herein are the same as those preferred in previously incorporated U.S. Prov. Application No. 60/294,794, and specific reference may be had thereto for further details.

Ligands of the formula (II) can be found in U.S. patent application Ser. No. 09/871,100, filed May 31, 2001 (incorporated by reference herein for all purposes as if fully set forth), along with methods of making these ligands and their transition metal complexes and methods for using these complexes in olefin polymerizations. Preferred ligands (II) herein are the same as those preferred in previously incorporated U.S. patent application Ser. No. 09/871,100, and specific reference may be had thereto for further details.

Ligands of formulas (III) through (V) can be found in U.S. patent application Ser. No. 09/871,099, filed May 31, 2001 (incorporated by reference herein for all purposes as if fully set forth), along with methods of making these ligands and their transition metal complexes and methods for using these complexes in olefin polymerizations. Preferred ligands (III) through (V) herein are the same as those preferred in U.S. patent application Ser. No. 09/871,099 and, again, specific reference may be had thereto for further details.

Besides describing the ligands of formulas (I) through (V) and their metal complexes and how to make them, previously incoporated U.S. Prov. Application No. 60/294,794, U.S. patent application Ser. No. 09/871,100 and U.S. patent application Ser. No. 09/871,099 also describe the desired oxidation state(s) of the metal complexes and the number and types of additional ligands that may be bound to the metal, including ligands that are useful for inserting the olefin. These references also describe the types of olefins that may be polymerized, conditions for activating the transition metal complexes (where needed), useful cocatalyst(s), useful counterions (where applicable), and other polymerization conditions (e.g., pressure, temperature). Another useful general reference on late transition metal polymerization catalysts and processes is S. D. Ittel, L. K. Johnson and M. Brookhart, Chem. Rev., vol. 100, p. 1169-1203 (2000), which is hereby included by reference. These and many other references describe variations on the use of polymerization catalysts, such as the use of supports, chain transfer agents, mixed (two or more) catalysts, process types (for example gas phase, liquid slurry, etc.).

In a preferred embodiment of the present invention, the metal complex is based upon Ni, Pd, Ti or Zr, with Ni being especially preferred.

Copolymerizations of norbornene-type monomers catalyzed by the nickel catalysts disclosed herein often exhibit high productivities. In particular, good productivities are often observed at elevated temperatures and/or in the presence of polar norbornene-type monomers relative to previously reported nickel-catalyzed norbornene-type monomer copolymerizations. For comparison, see U.S. Pat. No. 5,929,181, which is incorporated by reference herein for all purposes as if fully set forth.

In the polymerization processes disclosed herein, the temperature at which the polymerization is carried out is generally about −100° C. to about 200° C., and preferably about 0° C. to about 160° C. Temperatures ranging from about 20° C. to about 140° C. are especially preferred. The ethylene pressure is preferably about atmospheric pressure to about 30,000 psig, with pressures ranging from about atmospheric pressure to about 4000 psig being preferred, and pressures ranging from about atmospheric to about 1000 psig being especially preferred.

It is particularly noteworthy, however, that it is often preferred to carry out the processes of the present invention at temperatures somewhat higher than are used for many of the copolymerizations of ethylene and norbornene-type monomers described in references incorporated herein. This often results in higher productivities and/or in higher incorporations of the norbornene-type comonomers into the copolymers. Typically these “higher” temperatures range from about 60° C. to about 140° C.

Particularly depending upon the catalyst, the type of polymerization process used, and the product desired (for example, level of branching, norbornene-type monomer incorporation, and polymer molecular weight), optimum conditions for any particular polymerization may vary. The examples described herein, together with information in available references, allow one of ordinary skill in the relevant art to optimize the first process with relatively little experimentation. Generally speaking the higher the relative concentration of norbornene-type monomer present in the process and/or the higher the temperature, the higher the amount of norbornene-type comonomer which will be incorporated into the final polymer product.

Copolymers of ethylene and norbornene-type monomers may contain “abnormal” branching (see for example previously incorporated U.S. Pat. No. 5,866,663 for an explanation of “abnormal” branching). These polymers may typically contain more than 5 methyl ended branches per 1000 methylene groups in polyethylene segments in the polymer, more typically more than 10 methyl ended branches, and most typically more than 20 methyl ended branches. Branching levels may be determined by NMR spectroscopy, see for instance previously incorporated U.S. Pat. No. 5,866,663 and other well-known references for determining branching in polyolefins. By “methyl ended branches” are meant the number of methyl groups corrected for methyl groups present as end groups in the polymer. Also not included as methyl ended branches are groups which are bound to a norbornane ring system as a side group, for example a methyl attached directly to a carbon atom which is bound to a ring atom of a norbornane ring system. These corrections are well known in the art. The branches can impart improved solubility to the ethylene copolymers, which can be advantageous for a number of purposes, including the preparation of photoresists and other materials.

The copolymers of ethylene and one or more norbornene-type comonomers produced by the process disclosed herein may be random or alternating depending on the choice of catalyst and/or the relative ratio of the monomers used. A range of polymer morphologies can be produced with these catalysts, varying from amorphous to crystalline. The full range of norbornene incorporation (0 to 100 mol %) can be achieved as well, with about 0.1 to about 90 mol % being preferred. Typically, polymers disclosed herein contain at least one mole percent (based on the total number of all repeat units in the copolymer) of the norbornene-type monomer. Repeat units derived from one or more other copolymerizable monomers, such as alpha-olefins, may also optionally be present. Those copolymers that contain close to 50:50 mole ratio of ethylene and norbornene-type monomers will tend to be largely alternating. The copolymers range in molecular weight (Mw) from about 1,000 to about 250,000, often from about 2,000 to about 150,000.

The degree of incorporation of the norbornene-type monomer into the copolymer is dependent upon the selection of catalyst, the choice of ligand, and the reaction conditions. Variables include, for example, the donor atoms and steric bulk of the ligand, temperature, ethylene pressure, norbornene-type monomer structure and concentration, solvent, and catalyst and cocatalyst concentration.

The amount of each comonomer utilized in the process disclosed herein may be selected depending on the desired properties of the resulting copolymer. For example, if a polymer having a higher glass transition temperature is desired, such as between 120° C. to 160° C., it is necessary to incorporate a higher mole percent amount of norbornene, such as between 40 and 60%. Similarly, if a lower Tg polymer is desired, it is necessary to incorporate a lower mole percent of norbornene, such as between 20 and 30 mole percent to give a Tg between 30° C. and 70° C. Different norbornene monomers give different behavior with regard to their effect on Tg. For example alkylnorbornenes all give lower Tg's than does norbornene itself at a given level of incorporation, with longer alkyl chains giving successively lower Tg's. On the other hand phenyl norbornene and polycyclic norbornene-type monomers give higher Tg's than does norbornene for a given level of incorporation. Furthermore, it is possible to control the glass transition temperature by using a mixture of different NB-type monomers. More specifically, by replacing some norbornene with a substituted norbornene, such as alkyl norbornene, a lower Tg polymer results as compared to the copolymer if only norbornene were used.

The instant method makes it possible to prepare copolymers of ethylene with NB-type monomers containing polar substituents such as esters, ethers, silyl groups, and fluorinated alcohols and ethers, as disclosed above in greater detail. The copolymers of the present invention may be prepared from 0 to 100 percent of functional NB-type monomers or a mixture of NB-type monomers may be utilized; such mixtures may contain 1 to 99 percent of non-functional and 1 to 99 percent of functional NB-type monomers.

Copolymers of ethylene and polar norbornene-type monomers have unique physical properties not possessed by other norbornene-type polymers. Thus such polymers have especially good adhesion to various other materials, including metals and other polymers, and thus may find applicability in electrical and electronic applications. A surface made from such copolymers also has good paintability properties. In addition, certain copolymers of ethylene and polar norbornene-type monomers are useful in photoresist compositions and antireflective coatings. Copolymers of ethylene and polar norbornene-type monomers are also useful as molding resins (if thermoplastic) or as elastomers (if elastomeric). These polar copolymers are also useful in polymer blends, particularly as compatibilizers between different types of polymers; for example polar copolymers of this invention may compatibilize blends of polyolefins such as polyethylene and more polar polymers such as poly(meth)acrylates, polyesters, or polyamides.

The amorphous copolymers prepared according to the method of this invention are transparent. Additionally, they have relatively low density, low birefringence and low water absorption. Furthermore, they have desirable vapor barrier properties and good resistance to hydrolysis, acids and alkali and to weathering; very good electrical insulating properties, thermoplastic processing characteristics, high stiffness, modulus, hardness and melt flow. Accordingly, these copolymers may be used for optical storage media applications such as CD and CD-ROM, in optical uses such as lenses and lighting articles, in medical applications where gamma or steam sterilization is required, as films and in electronic and electrical applications.

Copolymers of ethylene and norbornene-type monomers with lower Tg's, e.g., those containing lower amounts of norbornene-type monomers, are useful as adhesives, crosslinkers, films, impact modifiers, ionomers and the like.

The catalysts of this invention may be employed as supported or unsupported materials and the polymerizations of this invention may be carried out in bulk or in a diluent. If the catalyst is soluble in the NB-type monomer being copolymerized, it may be convenient to carry out the polymerization in bulk. More often, however, it is preferable to carry out the copolymerization in a diluent. Any organic diluent or solvent which does not adversely interfere with the copolymerization process and is a solvent for the monomers may be employed. The preferred diluents are aliphatic and aromatic hydrocarbons such as isooctane, cyclohexane, toluene, p-xylene, and 1,2,4-trichlorobenzene, with the aromatic hydrocarbons being most preferred.

### EXAMPLES

In the Examples, all pressures are gauge pressures given in psi. The following abbreviations are used:

Am—amyl

Ar—aryl

BAF—tetrakis(3,5-trifluoromethylphenyl)borate

BArF—tetrakis(pentafluorophenyl)borate

BHT—2,6-di-t-butyl-4-methylphenol

Bu—butyl

CB—chlorobenzene

Cmpd—compound

DSC—differential scanning calorimetry

E—ethylene

Eoc—end-of-chain

Equiv—equivalent

Et—ethyl

GPC—gel permeation chromatography

ΔH_{f}—heat of fusion (in J/g)

Hex—hexyl

Incorp—incorporation

i-Pr—iso-propyl

M.W.—molecular weight

Me—methyl

MeOH—methanol

MI—melt index

Mn—number average molecular weight

Mp—peak average molecular weight

Mw—weight average molecular weight

Mol % or Mole %: Mole percent incorporation of a specified monomer in a polymer

Nd:—not determined

PDI—polydispersity; M_{w}/Mₙ

PE—polyethylene

Ph—phenyl

Press—pressure

RB—round-bottomed

RI—refractive index

Rt or RT—room temperature

t-Bu—t-butyl

TCB—1,2,4-trichlorobenzene

THF—tetrahydrofuran

TMEDA or tmeda: tetramethyl ethylene diamine

TO—number of turnovers per metal center=(moles monomer consumed, as determined by the weight of the isolated polymer or oligomers) divided by (moles catalyst)

tol—toluene

Total Me—Total number of methyl groups per 1000 methylene groups as determined by ¹H or ¹³C NMR analysis

UV—ultraviolet

### Examples 1-52

General Information Regarding Catalyst Syntheses:

Syntheses of catalysts similar to N-1 through N-8 and E-10 through E-15 are found in previously incorporated U.S. patent application Ser. No. 09/871,099. Syntheses of compounds similar to E-1 through E-7 are found in previously incorporated U.S. Prov. Application No. 60/294,794. Syntheses similar to compound E-8 are found in previously incoorporated U.S. patent application Ser. No. 09/871,100. The synthesis of E-9 is described below (Examples 19-21).

General Polymerization Procedure

In a nitrogen-purged drybox, a glass insert was loaded with the nickel compound. Optionally, a Lewis acid (typically B(C₆F₅)₃ or BPh₃) and/or NaBAF was/were also added to the insert. Next, the specified solvent(s) was/were added to the glass insert followed by the addition of the norbornene-type monomer(s) and any other additional comonomer(s). The insert was greased and capped. The glass insert was then loaded in a pressure tube inside the drybox. The pressure tube was then sealed, brought outside of the drybox, connected to the pressure reactor, placed under the desired ethylene pressure and shaken mechanically. After the stated reaction time, the ethylene pressure was released and the glass insert was removed from the pressure tube. The polymer was separated into methanol-soluble and -insoluble fractions by the addition of MeOH (˜20 mL). The insoluble fraction was collected on a frit and rinsed with MeOH. Optionally, the MeOH was then removed in vacuo to give the MeOH-soluble fraction. The polymers were transferred to pre-weighed vials and dried under vacuum overnight. The polymer yield and characterization were then obtained.

NMR Characterization

¹H NMR spectra were obtained at 113° C. in TCE-d₂ using a Bruker 500 MHz spectrometer. ¹³C NMR spectra were obtained unlocked at 140° C. using 310 mg of sample and 60 mg CrAcAc in a total volume of 3.1 mL TCB using a Varian Unity 400 NMR spectrometer or a Bruker Avance 500 MHz NMR spectrometer with a 10 mm probe. Total methyls per 1000 CH₂ were measured using different NMR resonances in ¹H and ¹³C NMR spectra. Because of accidental overlaps of peaks and different methods of correcting the calculations, the values measured by ¹H and ¹³C NMR spectroscopy will not be exactly the same, but they will be close, normally within 10-20% at low levels of comonomer incorporation. In ¹³C NMR spectra, the total methyls per 1000 CH₂ are the sums of the 1B₁, 1B₂, 1B₃, and 1B₄₊, EOC resonances per 1000 CH₂. The total methyls measured by ¹³C NMR spectroscopy do not include the minor amounts of methyls from the methyl vinyl ends. In ¹H NMR spectra, the total methyls are measured from the integration of the resonances from 0.6 to 1.08 ppm and the CH₂'s are determined from the integral of the region from 1.08 to 2.49 ppm. It is assumed that there is 1 methine for every methyl group, and ⅓ of the methyl integral is subtracted from the methylene integral to remove the methine contribution.

Molecular Weight Characterization

GPC molecular weights are reported versus polystyrene standards. Unless noted otherwise, GPC's were run with RI detection at a flow rate of 1 mL/min at 135° C. with a run time of 30 min. Two columns were used: AT-806MS and WA/P/N 34200. A Waters RI detector was used and the solvent was TCB with 5 grams of BHT per gallon. In addition to GPC, molecular weight information was at times determined by ¹H NMR spectroscopy (olefin end group analysis) and by melt index measurements (g/10 min at 190° C. (2.16 kg)).

In the examples 1-52, the following norbornene-type monomers were used:

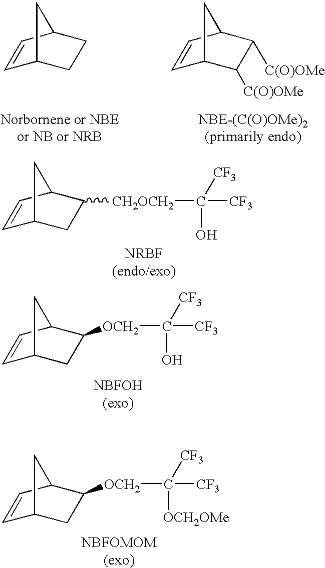

In the examples 1-23 the following nickel compounds were used:

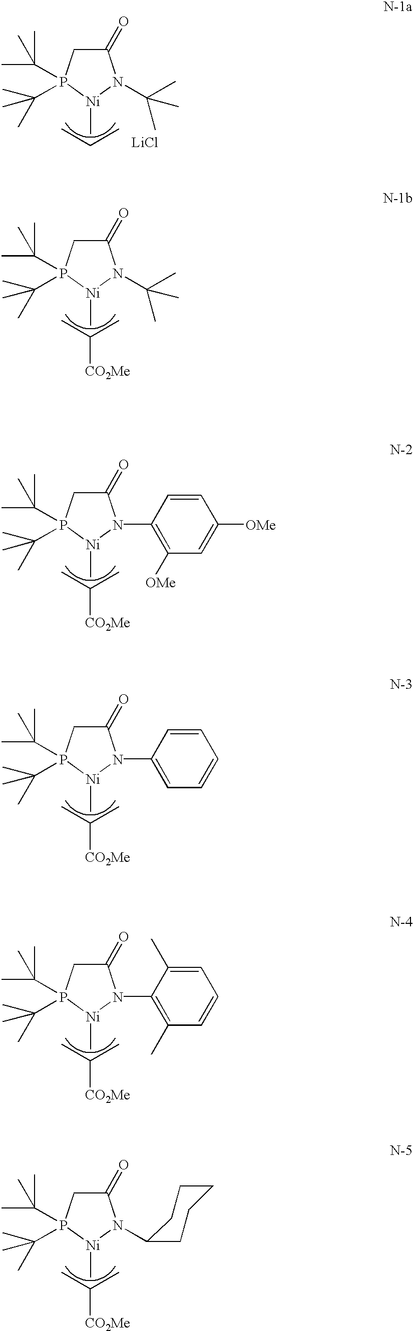

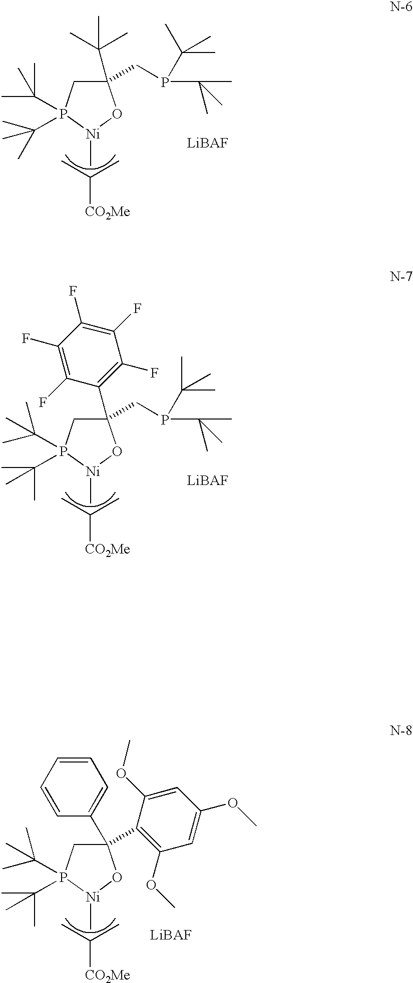

In the examples 27-52, the following nickel compounds were used:

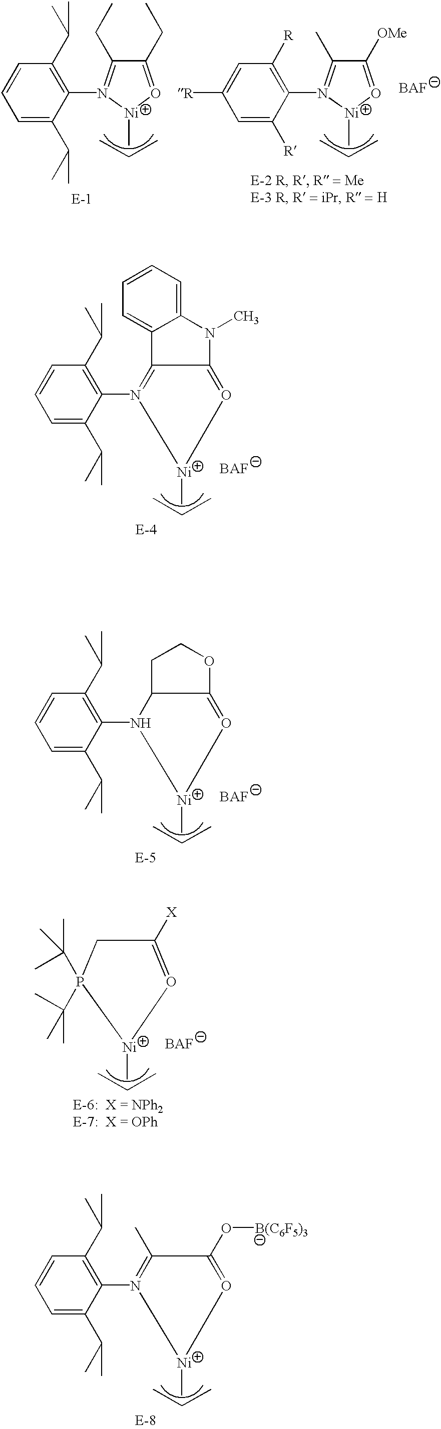

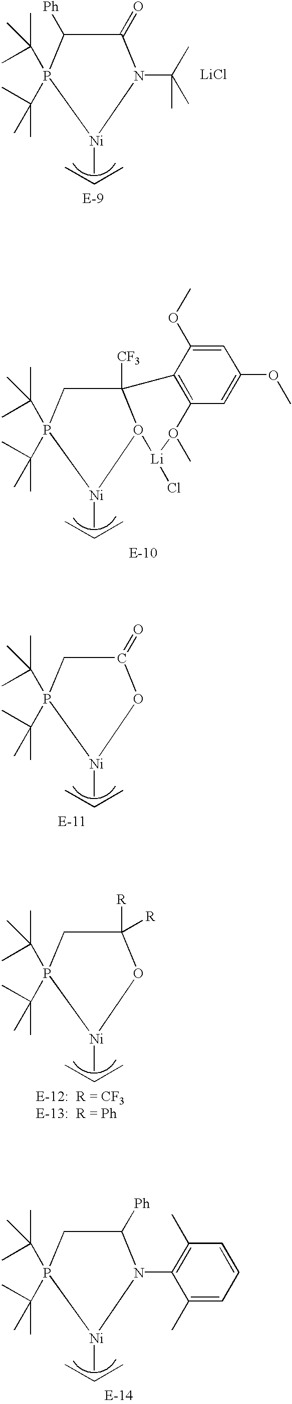

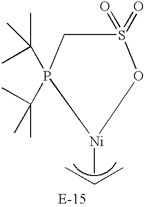

TABLE 1
Ethylene/NBFOH Copolymerizations (150 psi; 205 mg B(C₆F₅)₃;
2 mL NBFOH; 8 mL p-Xylene; 18 h)

| | | | | NBFOH | | |
|---|---|---|---|---|---|---|
| | Cmpd | Temp | Yield | Incorp. | | Total |
| Ex | (mmol) | ° C. | g | mol % | M.W. | Me |
| 1 | N-7 | 60 | 0.44 | 0.65 | Mₚ = 777; M_{w} = 7,986; | 15.6 |
| | (0.02) | | | (¹³C) | Mₙ = 1,118; PDI = 7.14 | (¹³C) |
| 2 | N-6 | 60 | 1.24 | Trace | Mₚ = 5,881; M_{w} = 6,922; | 16.1 |
| | (0.02) | | | (¹³C) | Mₙ = 2,791; PDI = 2.48 | (¹H) |
| 3 | N-5 | 60 | 2.44 | 0.27 | Mₚ = 6,487; M_{w} = 7,890; | 19.2 |
| | (0.02) | | | (¹³C) | Mₙ = 3,337; PDI = 2.36 | (¹³C) |
| 4 | N-8 | 60 | 2.19 | 0.22 | Mₚ = 5,073; M_{w} = 5,980; | 15.3 |
| | (0.02) | | | (¹³C) | Mₙ = 2,759; PDI = 2.17 | (¹³C) |
| 5 | N-1b | 120 | 0.38 | 0.39 | Mₚ = 4,452; M_{w} = 7,539; | 7.3 |
| | (0.005) | | | (¹³C) | Mₙ = 2,526; PDI = 2.98 | (¹³C) |
| 6 | N-5 | 120 | 0.34 | 0.46 | Mₚ = 5,829; M_{w} = 7,514; | 10.9 |
| | (0.005) | | | (¹³C) | Mₙ = 1,944; PDI = 3.87 | (¹³C) |

TABLE 2
Ethylene/NRBF Copolymerizations (Total Volume NRBF + p-Xylene = 10
mL; 150 psi Ethylene; 205 mg B(C₆F₅)_{3; 18 h)}

| | | | | | NRBF | | |
|---|---|---|---|---|---|---|---|
| | Cmpd | Temp | NRBF | Yield^{a} | Incorp | | Total |
| Ex | (mmol) | ° C. | mL | g | Mol % | M.W. | Me |
| 7 | N-1a | 60 | 4 | 2.64 | 3.08 | Mₚ = 16,574; M_{w} = 17,428; | 24.0 |
| | (0.04) | | | | (¹³C) | Mₙ = 4,796; PDI = 3.63 | (¹³C) |
| 8 | N-1a | 60 | 2 | 4.12 | 1.57 | Mₚ = 12,408; M_{w} = 14,206; | 16.3 |
| | (0.04) | | | | (¹³C) | Mₙ = 5,798; PDI = 2.45 | (¹³C) |
| 9 | N-1a | 90 | 4 | 3.72 | 2.34 | Mₚ = 7,045; M_{w} = 7,850; | 20.0 |
| | (0.04) | | | | (¹³C) | Mₙ = 2,452; PDI = 3.20 | (¹³C) |
| 10 | N-1a | 90 | 2 | 9.19 | 2.15 | Mₚ = 7,599; M_{w} = 8,085; | 19.2 |
| | (0.04) | | | | (¹³C) | Mₙ = 3,313; PDI = 2.44 | (¹³C) |
| 11 | N-1a | 120 | 4 | 14.69 | 4.80 | | 32.0 |
| | (0.04) | | | | (¹³C) | | (¹³C) |
| 12 | N-1a | 120 | 2 | 17.96 | 0.79 | Mₚ = 4,673; M_{w} = 5,037; | 15.8 |
| | (0.04) | | | | (¹³C) | Mₙ = 1,937; PDI = 2.60 | (¹³C) |

^{a}Yield in grams of MeOH-insoluble polymer fractions.

MeOH soluble polymer fractions were also isolated for the polymerizations of Examples 7-12. The ¹H NMR spectra and solubility of these fractions indicate that they have high NRBF incorporation (>50 mol % by ¹H NMR analysis). The homopolymer of NRBF is typically a white powder, as is the homopolymer of ethylene made by catalyst N-1a. Therefore, the appearance of these polymers as viscous oils and also their methanol-solubility is consistent with them being copolymers of NRBF and ethylene. Yield and appearance of MeOH-soluble fractions:

### Example 7

2.50 g viscous yellow oil;

### Example 8

2.11 g viscous yellow oil;

### Example 9

1 g viscous yellow oil;

### Example 10

0.34 g viscous yellow oil;

### Example 11

1.18 g viscous yellow oil;

### Example 12

0.44 g viscous yellow oil.

TABLE 3
Ethylene/NBFOH Copolymerizations (Total Volume NBFOH + p-Xylene =
10 mL; 50 psi Ethylene; 90° C.; 205 mg B(C₆F₅)_{3; 177 mg)}

| | | | | NBFOH | | |
|---|---|---|---|---|---|---|
| | Cmpd | NBFOH | Yield^{a} | Incorp | | Total |
| Ex | (mmol) | mL | g | mol % | M.W. | Me |
| 13 | N-2 | 2 | 0.431 | 0.56 | Mₚ = 6,615; M_{w} = 7,448; | 12.1 |
| | (0.04) | | | (¹³C) | Mₙ = 3,291; PDI = 2.26 | (¹³C) |
| 14 | N-3 | 2 | 0.301 | 0.05 | Mₚ = 7,319; M_{w} = 11,488; | 12.7 |
| | (0.04) | | | (¹H) | Mₙ = 3,474; PDI = 3.31 | |
| 15 | N-4 | 2 | 0.119 | Trace | | |
| | (0.04) | | | (¹H) | | |
| 16 | N-1a | 2 | 1.07 | 0.75 | Mₚ = 6,189; M_{w} = 8,576; | 14.4 |
| | (0.04) | | | (¹³C) | Mₙ = 2,670; PDI = 3.21 | (¹³C) |
| 17 | N-1a | 4 | 1.46 | 0.85 | Mₚ = 5,672; M_{w} = 8,429; | 130.4 |
| | (0.04) | | | (¹³C) | Mₙ = 3,561; PDI = 2.37 | (¹³C) |

^{a}Yield in grams of MeOH-insoluble polymer fractions.

MeOH soluble polymer fractions were also isolated for the polymerizations of Examples 13-17. The solubility of these fractions indicates that they have high NBFOH incorporation. The homopolymer of NBFOH is typically a white powder, as is the homopolymer of ethylene made by catalysts N-1a through N-4. Therefore, the appearance of these polymers as viscous oils/amorphous solids and also their methanol-solubility is consistent with them being copolymers of NBFOH and ethylene. Yield and appearance of MeOH-soluble fractions:

### Example 13

1.12 g brown oil/solid;

### Example 14

0.98 g yellow oil/solid;

### Example 15

1 g tan oil/solid;

### Example 16

1.03 g tan oil/solid;

### Example 17

1.27 g brown oil/solid.

TABLE 4
Ethylene/NRBF Copolymerizations (Total Volume NRBF + p-Xylene = 10
mL; 205 mg B(C₆F₅)_{3; 8 h)}^{a}

| | | | | | | NRBF | | |
|---|---|---|---|---|---|---|---|---|
| | Cmpd | Press | Temp | NRBF | Yield | Incorp | | Total |
| Ex | (mmol) | psi | ° C. | mL | g | mol % | M.W. | Me |
| 18 | N-1a | 1000 | 110 | 1 | 14.52 | 0 | Mₚ = 6,950; | |
| | (0.0025) | | | | | (¹³C) | M_{w} = 7,811; | |
| | | | | | | | Mₙ = 2.056; | |
| | | | | | | | PDI = 3.80 | |
| 19 | N-1a | 1000 | 110 | 2 | 20.89 | 0.44 | | 9.2 |
| | (0.0025) | | | | | (¹³C) | | (¹³C) |
| 20 | N-1a | 150 | 25 | 4 | 1.50 | 3.12 | | 5.9 |
| | (0.02) | | | | | (¹³C) | | (¹³C) |
| 21 | N-1a | 150 | 25 | 2 | 0.24 | 6.2 | | |
| | (0.02) | | | | | (¹H) | | |
| 22 | N-1a | 50 | 25 | 2 | 0.92 | 0.48 | Mₚ = 50,411; | 5.1 |
| | (0.02) | | | | | (¹³C) | M_{w} = 49,558; | (¹³C) |
| | | | | | | | Mₙ = 24,614; | |
| | | | | | | | PDI = 2.01 | |

^{a}177 mg of NaBAF were added to the polymerizations of Examples 18 and 19.

TABLE 5
Ethylene/NBE-(C(O)OMe)₂ Copolymerization (1 g NBE-(C(O)OMe)₂;
9 mL p-Xylene; 205 mg B(C₆F₅)₃; 177 mg NaBAF; 18 h)

| | | | | | NRBF | | |
|---|---|---|---|---|---|---|---|
| | Cmpd | Press | Temp | Yield | Incorp | | Total |
| Ex | (mmol) | psi | ° C. | g | mol % | M.W. | Me |
| 23 | N-1a | 1000 | 110 | 14.52 | 0.13 | Mₚ = 6,950; | 7.7 |
| | (0.005) | | | | (¹³C) | M_{w} = 7,811; | |
| | | | | | | Mₙ = 2,056; | |
| | | | | | | PDI = 3.80 | |

TABLE 6
¹³C NMR Branching Analysis for Some Ethylene Copolymers
(MeOH-Insoluble Fractions) of NRBF and NBFOH and
NBE-(C(O)OMe)₂

| | Total | | | | | Hex⁺ & | Am⁺ & | Bu⁺ & |
|---|---|---|---|---|---|---|---|---|
| Ex | Me | Me | Et | Pr | Bu | eoc | eoc | eoc |
| 1 | 15.6 | 4.8 | 1.4 | 0.1 | 0.5 | 10.5 | 9.0 | 9.3 |
| 3 | 19.2 | 11.4 | 1.7 | 0.5 | 1.3 | 5.1 | 5.5 | 5.5 |
| 4 | 15.3 | 3.5 | 3.3 | 0.3 | 1.3 | 6.0 | 5.7 | 8.2 |
| 5 | 7.3 | 1.3 | 0.3 | 0.1 | 0.1 | 3.9 | 4.2 | 5.6 |
| 6 | 10.9 | 3.5 | 1.4 | 0.3 | 0.3 | 4.4 | 5.8 | 5.8 |
| 7 | 24.0 | 17.2 | 2.1 | 0.2 | 0.6 | 2.5 | 4.4 | 4.4 |
| 8 | 16.3 | 10.2 | 2.2 | 0.3 | 0.5 | 2.7 | 4.3 | 3.6 |
| 9 | 20.0 | 10.8 | 1.7 | 0.4 | 0.8 | 4.5 | 6.6 | 7.1 |
| 10 | 19.2 | 9.8 | 1.1 | 0.1 | 0.6 | 5.3 | 7.1 | 8.2 |
| 11 | 32.0 | 20.6 | 0.0 | 0.5 | 0.8 | 7.0 | 10.1 | 11.0 |
| 12 | 15.8 | 3.7 | 0.0 | 0.4 | 0.9 | 8.6 | 8.8 | 11.7 |
| 13 | 12.1 | 6.8 | 0.3 | 0.1 | 1.8 | 4.5 | 4.4 | 4.9 |
| 16 | 14.4 | 5.6 | 0.8 | 0.1 | 1.2 | 5.9 | 5.3 | 7.8 |
| 17 | 130.4 | 110.4 | 7.3 | 1.2 | 35.6 | 9.2 | 13.1 | 11.5 |
| 19 | 9.2 | 3.9 | 0.0 | 0.1 | 0.0 | 3.4 | 4.0 | 5.1 |
| 20 | 5.9 | 4.1 | 0.4 | 0.3 | 0.3 | 1.1 | 1.6 | 1.1 |
| 21 | 5.1 | 3.1 | 0.4 | 0.3 | 0.2 | 1.0 | 0.9 | 1.2 |
| 23 | 7.7 | 2.4 | 0.4 | 0.1 | 0.5 | 3.4 | 4.1 | 4.7 |

### Example 24

### Synthesis of Benzyl-di-tert-butylphosphine

Di-tert-butylchlorophosphine (75.0 g, 0.415 mole) and 0.5 mole of a 12 M solution of benzylmagnesium chloride in THF (200 mL) were refluxed under argon for 2 days. The reaction mixture was allowed to cool down to ambient temperature and an aqueous solution of ammonium chloride was added slowly. The organic phase was separated, and dried with magnesium sulfate. After the removal of the solvent, the product was purified by distillation in vacuum. The yield of benzyl-di-tert-butylphosphine was 94.3 g (96%) with b.p. 56-59° C./0.1 mm.

³¹P NMR (CDCl₃): δ36.63. ¹H NMR (CDCl₃): 1.18 (s, 9H, Me₃C), 1.20 (s, 9H, Me₃C), 2.90 (d, 2H, ²J_{PH}=2.92 Hz, P—CH₂—Ph), 7.1-7.6 (m, 5H, aromatic protons).

### Example 25

### Synthesis of the TMEDA lithium salt of benzyl-di-tert-butylphosphine

Benzyl-di-tert-butylphosphine (5.0 g, 0.021 mole), 2.705 g (0.023 mole) TMEDA, 20 mL of pentane and 15 mL of a 1.7 M solution of tert-butyllithium in pentane were stirred at room temperature under nitrogen atmosphere for one day. The volume of the reaction mixture was reduced. Slow crystallization allowed the isolation of 3.8 g (51% yield) lithium salt of benzyl-di-tert-butylphosphine as the TMEDA adduct, with m.p. at 98.6° C. Elemental analysis for C₂₁H₄₀LiN₂P: calculated % P 8.65; found % P 8.74. ³¹PNMR (THF-d₈) δ17.94. X-ray single crystal analysis also confirmed the composition.

### Example 26

### Synthesis of Catalyst E-9

In a drybox, to a −30° C. THF solution of tert-butylisocyanate (0.138 g in 15 mL THF) was added dropwise a −30° C. solution of the TMEDA lithium salt of benzyl-di-tert-butylphosphine in THF (0.50 g in 15 mL THF). As the orange solution warmed up to RT, solids formed. The thickened solution was stirred at RT overnight. To this solution was added 0.189 g [(allyl)NiCl]₂. The mixture was stirred overnight. The mixture was evaporated to dryness. The residue was extracted with toluene and was filtered through Celite®, followed by a toluene wash of the Celite®. The solution was evaporated to dryness and the solid was dried in vacuo overnight. Dark red-brown solid (0.579 g) was obtained.

TABLE 7
Ethylene/Norbornene Copolymerization Using 0.005 mmole
Ni Cmpd E-1, 7 mL TCB, 3 g Norbornene at 60° C. under
1000 psi Ethylene for 18 h

| | Yield | Mole % | |
|---|---|---|---|
| Ex | (g) | Norbornene | Mw/PDI |
| 27 | 3.254 | 36.8 | 20,168/2.9 |

TABLE 8
Ethylene/Norbornene Copolymerization Using 0.005 mmole
Ni Cmpd E-9, 8 mL TCB, 2 g Norbornene at 100° C. under
1000 psi Ethylene for 18 h

| | Yield | Mole % | |
|---|---|---|---|
| Ex | (g) | Norbornene | Mw/PDI |
| 28 | 1.252 | 0.7 | 11,568/2.0 |

TABLE 9
Ethylene/Norbornene Copolymerization Using 0.005 mmole Ni
Cmpd, 9 mL TCB, 1 g Norbornene at 60° C. under 600 psi
Ethylene for 18 h

| | | B(C₆F₅)₃ | BPh₃ | Yield | Mole % |
|---|---|---|---|---|---|
| Ex | Cmpd | (equiv) | (equiv) | (g) | Norbornene |
| 29 | E-10 | 40 | 0 | 2.325 | 3.5 |
| 30 | E-11 | 40 | 0 | 1.040 | 27.8 |
| 31 | E-6 | 0 | 0 | 0.781 | 6.5 |
| 32 | E-2 | 0 | 0 | 2.100 | 26.7 |
| 33 | E-4 | 0 | 0 | 0.714 | 20.7 |
| 34 | E-1 | 0 | 0 | 0.121 | 53.9 |
| 35 | E-8 | 0 | 0 | 5.015 | 14.8 |
| 36 | E-5 | 0 | 0 | 4.130 | 22.6 |
| 37 | E-3 | 0 | 0 | 7.197 | 9.8 |
| 38 | E-7 | 0 | 0 | 0.218 | 31.8 |
| 39 | E-12 | 0 | 40 | 6.680 | 3.7 |
| 40 | E-13 | 40 | 0 | 1.716 | 1.0 |
| 41 | E-14 | 40 | 0 | 0.128 | 80.0 |
| 42 | E-15 | 40 | 0 | 0.076 | 2.9 |

TABLE 10
Ethylene/NBFOH Copolymerization Using 0.02 mmole Ni Cmpd,
8 mL TCB, 2 mL NBFOH at 25° C. under 600 psi
Ethylene for 18 h

| | | B(C₆F₅)₃ | BPh₃ | Yield | Mole % |
|---|---|---|---|---|---|
| Ex | Cmpd | (equiv) | (equiv) | (g) | NBFOH |
| 43 | E-5 | 0 | 40 | 10.945 | 4.7 |
| 44 | E-3 | 0 | 40 | 6.157 | 5.8 |
| 45 | E-1 | 0 | 40 | 7.956 | 5.7 |
| 46 | E-8 | 0 | 40 | 5.028 | 7.0* |
| 47 | E-11 | 40 | 0 | 2.039 | 4.5 |

*The filtrate was evaporated to dryness. The residue was dissolved in Et₂O and precipitated with pentane. Repeated the Et₂O/pentane purification. Tacky solid polymer (0.386 g) was isolated as the second portion, which has an incorporation of NBFOH of 19.4 mole %.

TABLE 11
Ethylene/NBFOMOM Copolymerization Using 0.01 mmole
Ni Cmpd, 8 mL TCB, 2 mL NBFOMOM at 25° C. under
600 psi Ethylene for 18 h

| | | B(C₆F₅)₃ | Yield | Mole % |
|---|---|---|---|---|
| Ex | Cmpd | (equiv) | (g) | NBFOMOM |
| 48 | E-5 | 0 | 4.554 | 6.0 |
| 49 | E-3 | 0 | 6.756 | 2.6 |
| 50 | E-1 | 0 | 5.080 | 2.9 |
| 51 | E-8 | 0 | 7.553 | 11.2 |
| 52 | E-11 | 40 | 2.499 | 0.9 |

We claim:

1. A process for copolymerization of ethylene and a norbornene-type monomer, comprising the step of contacting, under polymerizing conditions, ethylene, one or more norbornene-type monomers, and a Group 3 through 11 (IUPAC) transition metal or lanthanide complex of a ligand selected from the group consisting of:
(a) a ligand of the formula (I) 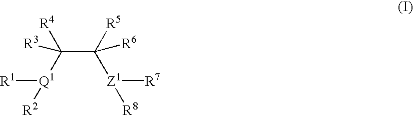
wherein:
Z¹ is nitrogen or oxygen; and
Q¹ is nitrogen or phosphorous;
provided that:
when Q¹ is phosphorous and Z¹ is nitrogen: R¹ and R² are each independently hydrocarbyl or substituted hydrocarbyl having an Eₛ of about −0.90 or less; R³, R⁴, R⁵, R⁶ and R⁷ are each independently hydrogen, hydrocarbyl or substituted hydrocarbyl; and R⁸ is aryl or substituted aryl, provided that any two of R³, R⁴, R⁵, R⁶, R⁷ and R⁸ vicinal or geminal to one another together may form a ring;
when Q¹ is phosphorous and Z¹ is oxygen: R¹ and R² are each independently hydrocarbyl or substituted hydrocarbyl having an Eₛ of about −0.90 or less; R³ and R⁴ are each independently hydrogen, hydrocarbyl or substituted hydrocarbyl; R⁵ and R⁷ taken together form a double bond; R⁸ is not present; and R⁶is —OR⁹, —NR¹⁰R¹¹, hydrocarbyl or substituted hydrocarbyl, wherein R⁹ is hydrocarbyl or substituted hydrocarbyl, and R¹⁰ and R¹¹ are each independently hydrogen, hydrocarbyl or substituted hydrocarbyl;
when Q¹ is nitrogen: R¹ is hydrocarbyl or substituted hydrocarbyl having an Eₛ of about −0.90 or less; R² and R³ are each independently hydrogen, hydrocarbyl or substituted hydrocarbyl, or taken together form a ring or a double bond; R⁴ is hydrogen, hydrocarbyl or substituted hydrocarbyl; Z¹ is oxygen; R⁶ and R⁷ taken together form a double bond; R⁸ is not present; R⁵ is —OR¹², —R¹³ or —NR¹⁴R¹⁵, wherein R¹² and R¹³ are each independently hydrocarbyl or substituted hydrocarbyl, and R¹⁴ and R¹⁵ are each hydrogen, hydrocarbyl or substituted hydrocarbyl; provided that when R² and R³ taken together form an aromatic ring, R¹ and R⁴ are not present;
(b) a ligand of the formula (II) 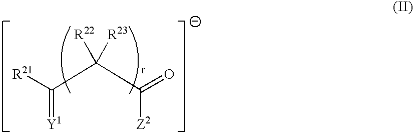
wherein:
Y¹ is oxo, NRₐ¹² or PRₐ¹²
Z² is O, NRₐ¹³, S or PRₐ¹³;
each of R²¹, R²² and R²³ is independently hydrogen, hydrocarbyl, substituted hydrocarbyl or a functional group;
r is 0 or 1;
each Rₐ¹² is independently hydrogen, hydrocarbyl, substituted hydrocarbyl or a functional group;
each Rₐ¹³ is independently hydrogen, hydrocarbyl, substituted hydrocarbyl or a functional group;
and provided that any two of R²¹, R²² and R²³ geminal or vicinal to one another taken together may form a ring; and
(c) a ligand of the formula (III), (IV) or (V) 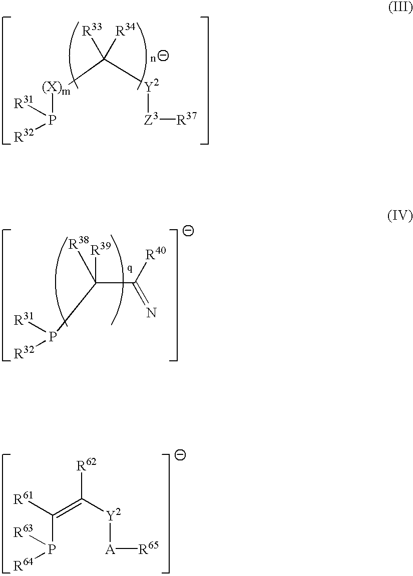
(V) wherein:
R³¹ and R³² are each independently hydrocarbyl, substituted hydrocarbyl or a functional group;
Y² is CR⁴¹R⁴², S(T), S(T)₂, P(T)Q³, NR⁶⁶ or NR⁶⁶NR⁶⁶;
X is O, CR³⁵R³⁶ or NR³⁵;
A is O, S, Se, N, P or As;
Z³ is O, S, Se, N, P or As;
each Q³ is independently hydrocarbyl or substituted hydrocarbyl;
R³³, R³³, R³⁴, R³⁵, R³⁶, R⁴¹ and R⁴² are each independently hydrogen, hydrocarbyl, substituted hydrocarbyl or a functional group;
R³⁷ is hydrogen, hydrocarbyl, substituted hydrocarbyl or a functional group, provided that when Z³ is O, S or Se, R³⁷ is not present;
R³⁸ and R³⁹ are each independently hydrogen, hydrocarbyl, substituted hydrocarbyl or a functional group;
R⁴⁰ is hydrogen, hydrocarbyl, substituted hydrocarbyl or a functional group;
each T is independently ═O or ═NR⁶⁰;
R⁶⁰ is hydrogen, hydrocarbyl, substituted hydrocarbyl or a functional group;
R⁶¹ and R⁶² are each independently hydrogen, hydrocarbyl, substituted hydrocarbyl or a functional group;
R⁶³ and R⁶⁴ are each independently hydrocarbyl or substituted hydrocarbyl, provided that each is independently an aryl substituted in at least one position vicinal to the free bond of the aryl group, or each independently has an Eₛ of −1.0 or less;
R⁶⁵ is hydrogen, hydrocarbyl, substituted hydrocarbyl or a functional group, provided that when A is O, S or Se, R⁶⁵ is not present;
each R⁶⁶ is independently hydrogen, hydrocarbyl, substituted hydrocarbyl or a functional group;
m is 0 or 1;
s is 0 or 1;
n is 0 or 1; and
q is 0 or 1;
and provided that:
any two of R³³, R³⁴, R³⁵, R³⁶, R³⁸, R³⁹, R⁴¹ and R⁴² bonded to the same carbon atom taken together may form a functional group;
any two of R³¹, R³², R³³, R³⁴, R³⁵, R³⁶, R³⁷, R³⁸, R³⁹, R⁴¹, R⁴², R⁶¹, R⁶², R⁶³, R⁶⁴, R⁶⁵ and R⁶⁶ bonded to the same atom or vicinal to one another taken together may form a ring; and
when said ligand is (III), Y² is C(O), Z³ is O, and R³¹ and R³² are each independently hydrocarbyl, then R³¹ and R³² are each independently an aryl substituted in one position vicinal to the free bond of the aryl group, or R³¹ and R³² each independently have an Eₛ of −1.0 or less.

2. The process of claim 1 wherein the norbornene-type monomer has the structure 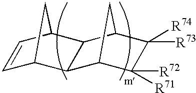
wherein
m′ is an integer from 0 to 5, and each of R⁷¹ to R⁷⁴ independently represents
hydrogen;
a halogen atom;
a linear or branched (preferably C₁ to C₁₀) alkyl;
an aromatic or saturated or unsaturated cyclic group;
a functional substituent selected from the group
—(CH₂)_{n′}—C(O)OR, —(CH₂)_{n′}—OR, —(CH₂)_{n′}—OC(O)R,
—(CH₂)_{n′}C(O)R, —(CH₂)_{n′}—OC(O)OR,
—(CH₂)_{n′}C(R)₂CH(R)(C(O)OR), or —(CH₂)_{n′}C(R)₂CH(C(O)OR)₂,
wherein
R represents hydrogen or linear and branched (preferably C₁ to C₁₀) alkyl;
a functional group containing the structure
—C(R_{f})(R_{f}′)OR_{b}
wherein
R_{f} and R_{f}′ are the same or different fluoroalkyl groups of from 1 to 10 carbon atoms or taken together are (CF₂)_{n*} wherein n* is 2 to 10; R_{b} is hydrogen or an acid- or base-labile protecting group;
or a silyl substituent represented by 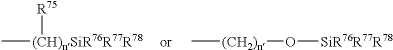
wherein
R⁷⁵ is hydrogen, methyl or ethyl,
each of R⁷⁶, R⁷⁷, and R⁷⁸ independently represents
a halogen selected from bromine, chlorine, fluorine or iodine,
linear or branched (preferably C₁ to C₂₀) alkyl,
linear or branched (preferably C₁ to C₂₀) alkoxy,
linear or branched (preferably C₁ to C₂₀) alkyl carbonyloxy (e.g., acetoxy),
linear or branched (preferably C₁ to C₂₀) alkyl peroxy (e.g., t-butyl peroxy),
substituted or unsubstituted (preferably C₆ to C₂₀) aryloxy,
n′ is an integer from 0 to 10, where preferably n′ is 0,
provided that
R⁷¹ and R⁷² can be taken together to form a (preferably C₁ to C₁₀) alkylidenyl group;
R⁷³ and R⁷⁴ can be taken together to form a (preferably C₁ to C₁₀) alkylidenyl group; or
R⁷¹ and R⁷⁴ can be taken together with the two ring carbon atoms to which they are attached to form a saturated cyclic group of 4 to 8 carbon atoms, wherein said cyclic group can be substituted by at least one of R⁷² and R⁷³.

3. The process of claim 1 wherein the transition metal is selected from the group consisting of Ni, Pd, Ti and Zr.

4. The process of claim 3 wherein the transition metal is Ni.

5. The process of claim 1 wherein ethylene and one or more norbornene-type comonomers are the only polymerizable olefins present.

6. The process of claim 1 wherein the temperature at which the components are contacted is greater than about 60° C.
